(19) United States
(12) Patent Application Publication
(10) Pub. No.: US 2009/0110026 A1
(43) Pub. Date: Apr. 30, 2009

(54) EXPENDABLE IMMERSION DEVICE

(75) Inventor: Michael Midash, Newtown, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HERAEUS ELECTRO-NITE CO., Langhorne, PA (US)

(21) Appl. No.: 12/257,986

(22) Filed: Oct. 24, 2008

Related U.S. Application Data
(60) Provisional application No. 60/982,304, filed on Oct. 24, 2007.

(51) Int. Cl. G01K 1/12

(52) U.S. Cl. 374/139; 374/E01.016

(57) ABSTRACT

An expendable immersion device for sensing characteristics of molten metal has a contact block and a receptacle tube. The contact block is slidingly disposed at least partially within a distal end of the receptacle tube. The expendable immersion devices includes a sensing element and a heat resistant tube. A distal end of the heat resistant tube is mounted to the sensing element. The sensing element extends partially into the interior of the heat resistant tube. A proximal end of the heat resistant tube is mounted over a distal end of the receptacle tube. A spring element is positioned over a proximal end of the contact block and abuts against the receptacle tube such that a force between the contact block and the sensing element is reduced when the heat resistant tube and sensing element are connected to the distal end of the contact block during assembly.

### CROSS-REFERENCE TO RELATED APPLICATIONS

This application claims the benefit of U.S. Provisional Patent Application No. 60/982,304 filed Oct. 24, 2007 entitled “Expendable Immersion Device and Pole Having a Spring Biased Contact Block,” incorporated by reference herein in its entirety.

### BACKGROUND OF THE INVENTION

The present invention relates to an expendable immersion device for use with a pole in measuring a characteristic of molten metal.

During the refining of molten metal, and particularly of molten steel, there is a need to measure parameters of the molten metal such as temperature and oxygen content. Referring to FIGS. 1 and 2, expendable immersion devices 10 are well known in the art for allowing operators to take such measurements while being situated a significant distance from the molten metal (not shown) due to the high temperatures involved. In order to take the measurements, a parameter sensing element 12 is secured, generally by some type of sealing adhesive 14, into a distal end of a hollow heat resistant or insulating tube 16. The parameter sensing element 12 includes a tail piece having electrical contacts (not shown) which extend into the insulating tube 16. In use, a manipulator or pole 18, usually a long metal tube or pipe, is inserted into the heat resistant tube 16 until the contacts on the tailpiece of the parameter sensing element 12 engage a contact block 22 at the end of the pole 18. The pole 18 serves to separate the user from the high temperature and also as a handle section to facilitate the immersion into and withdrawal of the parameter sensing element 12 from the molten metal. The heat resistant tube 16 helps to protect electrical components within the pole 18.

The heat resistant tube 16 and the sensing element 12 are disposable after a measurement is taken and a new heat resistant tube 16 and sensing element 12 unit is thereafter manually inserted onto the reusable pole 18 for taking subsequent measurements. During assembly, a user grasps the heat resistant tube 16 and slides a proximal end of the heat resistant tube 16 over a distal end of the pole 18. During assembly, the adhesive 14 holding the parameter sensing element 12 into the distal end of the heat resistant tube 16 may become cracked or partially broken away due to the application of excessive force during assembly of the expendable immersion device 10. If the damaged adhesive between the sensing element 12 and the heat resistant tube 16 is not noticed by the operator before use, the sensing element 12 may detach from the heat resistant tube 16 and molten metal will flow into the interior of the heat resistant tube 16 upon immersion of the tube 16 into the molten metal and destroy the parts of the pole 18 that are intended for re-use and are typically protected by the heat resistant tube 16.

Referring to FIG. 2, in order to reduce the force exerted on the sensing element 12 during assembly, an expendable immersion device 10 and pole 18 (disclosed in further detail in U.S. Pat. No. 4,528,849) has been developed to include a spring 20 positioned on the outside of a support member 24 between the immersion device 10 and the pole 18 such that a plug or contact block 22 is spring biased toward the distal end of the pole 18. The support member 24 is mounted to the pole 18. The bias of the spring 20 helps to absorb and prevent excessive forces between the sensing element 12 and the contact block 22. However, as shown in FIG. 2, numerous component parts are required to implement the spring 20 and the contact block 22 is not easily assembled to and removed from the pole 18.

What is needed, but not provided in the prior art, is an expendable immersion device and pole with a simplified configuration, with fewer component parts and easier assembly, for providing a spring biased contact block for preventing damage to the sealing adhesive between the heat resistant tube and the sensing element during assembly.

### BRIEF SUMMARY OF THE INVENTION

Briefly stated, the present invention is directed to an expendable immersion device for sensing characteristics of molten metal. The expendable immersion device has a contact block and a receptacle tube. The contact block is slidingly disposed at least partially within a distal end of the receptacle tube. The expendable immersion devices includes a sensing element and a heat resistant tube. A distal end of the heat resistant tube is mounted to the sensing element. The sensing element extends partially into the interior of the heat resistant tube. A proximal end of the heat resistant tube is mounted over a distal end of the receptacle tube. A spring element is positioned over a proximal end of the contact block and abuts against the receptacle tube such that a force between the contact block and the sensing element is reduced when the heat resistant tube and sensing element are connected to the distal end of the contact block during assembly.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a side elevational view of an expendable immersion device and pole known in the prior art;

FIG. 2 is an enlarged partial side cross sectional view of a portion of the expendable immersion device and pole shown in FIG. 1;

FIG. 3 is a side elevational view of an expendable immersion device and pole having a spring biased contact block in accordance with a first preferred embodiment of the present invention;

FIG. 4 is a perspective view of a contact block, receptacle tube and electrical wiring of the expendable immersion device and pole having a spring biased contact block shown in FIG. 3;

FIG. 5 is an enlarged partial cross sectional side view of the expendable immersion device and pole having a spring biased contact block shown in FIG. 3;

FIG. 6 an exploded side elevational view of the contact block, receptacle tube and electrical wiring of the expendable immersion device having a spring biased contact block shown in FIG. 4; and

FIG. 7 is a partial cross section view of an expendable immersion device and pole having a spring biased contact block in accordance with a second preferred embodiment of the present invention.

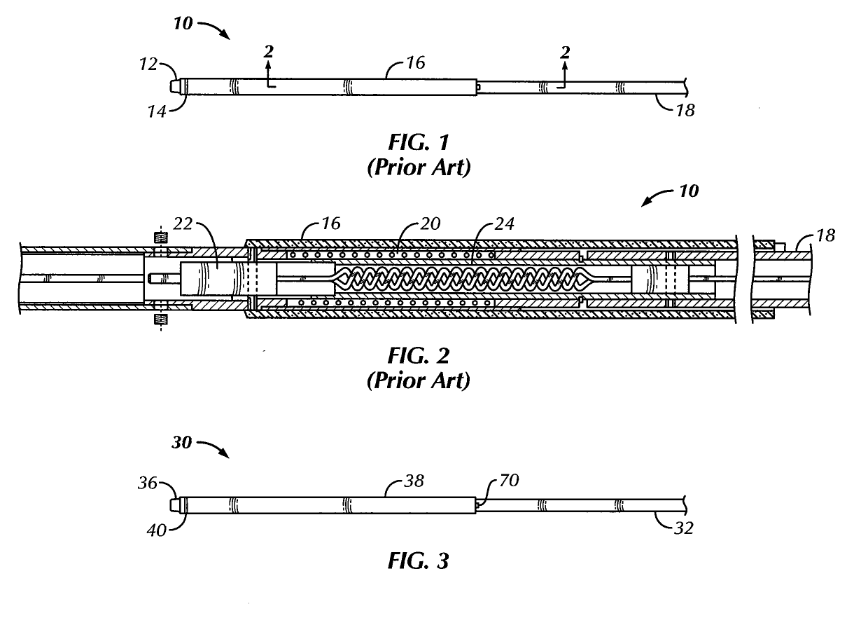

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of an expendable immersion device in accordance with the present invention, and designated parts thereof. Unless specifically set forth herein, the terms “a”, “an” and “the” are not limited to one element but instead should be read as meaning “at least one”. The terminology includes the words noted above, derivatives thereof and words of similar import.

Referring to the drawings in detail, wherein like reference numerals indicate like elements throughout, there is shown in FIGS. 3-6 a first preferred embodiment of an expendable immersion device, generally designated 30, in accordance with the present invention.

Referring to FIG. 3, the immersion device 30 is slidingly attached to an elongated hollow pole 32. The pole 32 is preferably cylindrical and comprised of a durable, lightweight and generally rigid material such as steel. Though it is preferred that the pole 32 be cylindrical, hollow and comprised of steel, it is within the spirit and scope of the present invention that the pole 32 have any shape, solid in cross section and or be comprised of any other suitable material such as aluminum.

Mounted to an immersion or distal end 34 (FIG. 5) of the pole 32 is a heat resistant tube 38 into which a sensing element 36 is secured into the distal end of the heat resistant tube 38. The sensing element 36 is preferably secured to the heat resistant tube 38 by a sealing adhesive 40. The sealing adhesive 40 is preferably an epoxy or glue. The heat resistant tube 38 is preferably a hollow cylindrical tube comprised of tightly wound cardboard. The tightly wound cardboard acts as an insulator and generally does not burn entirely through during the taking of a measurement. Though it is preferred that the heat resistant tube 38 be comprised of cardboard, the heat resistant tube 38 may be comprised of any heat resistant material capable of protecting the electrical components (not shown) within the immersion device 10 such as ceramic or layers of synthetic fibers.

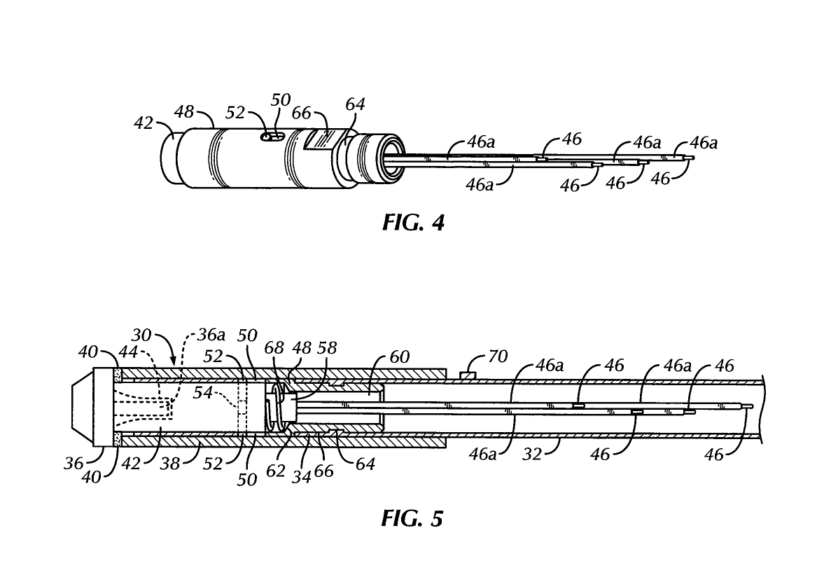

Referring to FIGS. 4 through 6, the pole 32 includes a contact block 42 for electrically connecting to a tail assembly 36a of the sensing element 36. The distal end of the contact block 42 includes an insert cavity 44 shown schematically in FIG. 5 for receiving the tail assembly 36a. During assembly of the immersion device 30 with the pole 32, the contact block 42 is slid into the proximal end of the heat resistant tube 38 until the contact block 42 becomes electrically connected to the tail assembly 36a.

A plurality of electrical wires 46 extend from the proximal end of the contact block 42. The electrical wires 46 conduct the electrical signals produced by the sensing element 36 such as temperature and oxygen measurements of the molten metal (not shown). The electrical wires 46 each include an insulating cover 46a to protect the electrical wires 46 and insulate the electrical wires 46 from each other. The electrical wires 46 extend through the pole 32 and connect to a receiving device (not shown) to record and/or display the measurements of the molten metal. Though a plurality of electrical wires 46 is shown, the measurements may be transmitted wirelessly. Also, additional electrical components and details may be included in the immersion device 30 and pole 32 and are not shown or described in the interest of convenience only and is not limiting. Though electrical connections are shown and described in conjunction with the preferred embodiment of present invention, different sensing and connection components may be used such as electrochemical and pneumatic. An example of such a device is shown in U.S. Pat. No. 5,902,468.

The contact block 42 is slidingly disposed within a receptacle tube 48. Though it is preferred that the contact block 42 extend slightly from the receptacle tube 48, the contact block 42 may be partially or entirely disposed within the receptacle tube 48. The receptacle tube 48 includes at least one but preferably two diametrically opposed axially extending elongated slots 50. At least one, but preferably two or more pins 52 are slidingly disposed within the slots 50 and extend into a cavity 54 in the contact block 42 generally perpendicular to the longitudinal axis of the immersion device 10. It is preferred that the slots 50 are of sufficient length as to prevent the spring 68 from completely compressing or bottoming out. Though it is preferred that two pins 52 be used, the pins 52 may be any type of fastener or extension from the contact block 42.

When assembled, the pins 52 and corresponding slots 50 prevent the contact block 42 from detaching from the receptacle tube 48 but allow the contact block 42 to slide within the receptacle tube 48 a distance equal to the length of the slots 50. The contact block 42 preferably includes a tapered or step down proximal extension 58 having a smaller outer diameter than the outer diameter of the remainder of the contact block 42. The proximal extension 58 of the contact block 42 preferably fits within a tapered or step down proximal guide 60 of the receptacle tube 48. An interior edge 62 is formed between the interior of the receptacle tube 48 and the proximal guide 60. The exterior of the proximal guide 60 also preferably includes a groove 64 that extends radially inwardly and indents 66 for securely attaching the pole 32 to the receptacle tube 48. Though a snap fit between the receptacle tube 48 and the pole 32 is preferred, a different connection between the receptacle tube 48 and the pole 32 may be used such as friction fit, adhesive or a mechanical latch.

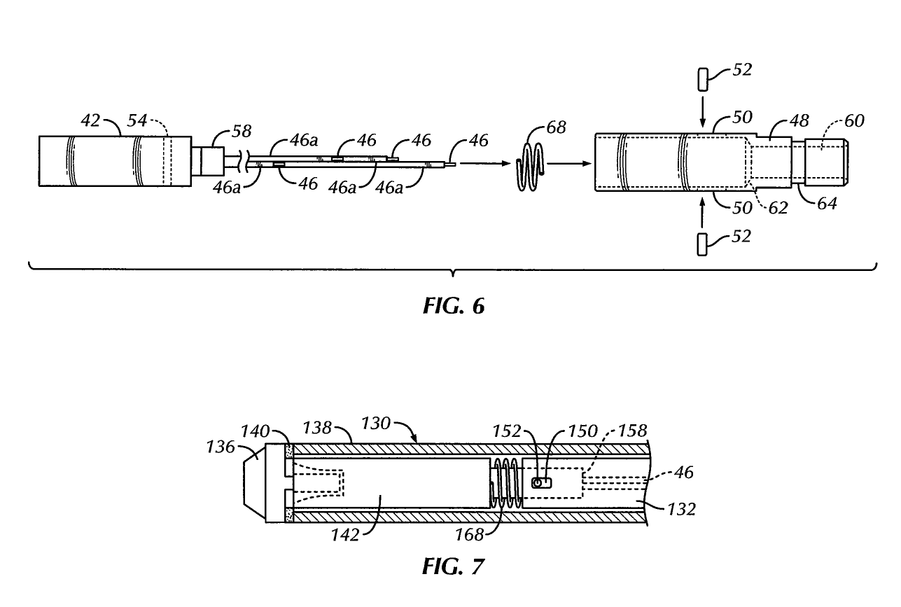

Referring specifically to FIGS. 5 and 6, a spring 68 is positioned over the proximal extension 58 and located within the receptacle tube 48. The spring 68 is positioned between the contact block 42 and the interior edge 62 of the receptacle tube 48 such that the contact block 42 is spring biased away from the interior edge 62 of the receptacle tube 48. Though a helical compression spring 68 is preferred, the spring 68 may be a different type of mechanical spring, a hydraulic or pneumatic spring or other biasing member. The spring 68 may also be an elastomeric compression sleeve.

It will be appreciated by one skilled in the art that when the heat resistant tube 38 and sensing element 36 are forcibly slid onto the distal end of the pole 32 such that the contact block 42 makes contact with the sensing element 36, the compression of the spring 68 provides a cushioning or shock absorbing effect to prevent damage to the sealing adhesive 40 while providing sufficient opposing force to ensure that the contact block 42 and the sensing element 36 become electrically connected. By reducing the force of the impact that is normally presented when the distal end of the contact block 42 contacts the sensing element 36, the possibility of destroying the seal formed by the sealing adhesive 40 between the heat resistant tube 38 and the sensing element 36 is greatly reduced.

While the shock absorbing feature provided by the spring 68 significantly reduces the likelihood of damaging the seal produced by the sealing adhesive 40 between the heat resistant tube 38 and the sensing element 36, a stop 70 may also be provided on the pole 32 for preventing over insertion of the heat resistant tube 38 with respect to the pole 32. Once the contact block 42 becomes electrically connected to the sensing element 36 and the contact block is urged against a completely compressed spring 68, the proximal end of the heat resistant tube 38 contacts the stop 70 to prevent the contact block 42 and receptacle tube 48 from extending further within the heat resistant tube 38 and thereby detaching the sensing element 36 or otherwise damaging the sealing adhesive 40 between the sensing element 36 and the heat resistant tube 38.

Referring to FIG. 7, there is shown a second preferred embodiment of the immersion device, generally designated 130. The immersion device 130 is similar to the first preferred embodiment of the immersion device 30 except that the receptacle tube 48 has been eliminated and the position of the slots 50 and pins 52 have been moved. The immersion device 130 includes similar elements to the immersion device 30 and such elements have been similarly numbered with the addition of a leading “1”. Because the receptacle tube 48 has been removed, the proximal end 158 of the contact block 152 is directly disposed within the pole 132. Additionally, the slots 150 extend through the pole 132 and receive pins 152 to prevent the contact block 142 from detaching from the pole 132. The spring 168 is positioned between the contact block 142 and the pole 132 to spring bias the contact block 142 similar to the immersion device 30 of the first preferred embodiment. Though it is preferred that the contact block 142 extend into the pole 132, the orientation may be reversed such that the pole 132 is received in the contact block 142.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. An expendable immersion device for sensing characteristics of molten metal and having a contact block, the expendable immersion device comprising:
a receptacle tube, the contact block being slidingly disposed at least partially within a distal end of the receptacle tube;
a sensing element;
a heat resistant tube, a distal end of the heat resistant tube being mounted to the sensing element, the sensing element extending partially into the interior of the heat resistant tube, a proximal end of the heat resistant tube being mounted over a distal end of the receptacle tube; and
a spring element positioned over a proximal end of the contact block and abutting against the receptacle tube such that a force between the contact block and the sensing element is reduced when the heat resistant tube and sensing element are connected to the distal end of the contact block during assembly.

2. The expendable immersion device of claim 1, wherein a pin extends from the contact block and is disposed within a slot in the receptacle tube for preventing the contact block from detaching from the receptacle tube.

3. The expendable immersion device of claim 2, wherein the receptacle tube is a pole that extends from the heat resistant tube and the pin is located proximal to the spring element.

4. The expendable immersion device of claim 1, wherein the receptacle tube is mounted to a pole.

5. The expendable immersion device of claim 1, wherein the spring element is a helical compression spring.

6. The expendable immersion device of claim 1, wherein the sensing element is adhered to the heat resistant tube.

7. The expendable immersion device of claim 1, wherein the receptacle tube has a reduced diameter portion and the spring abuts an internal edge created by the reduced diameter portion.
